(19) United States
(12) Patent Application Publication
(10) Pub. No.: US 2011/0202575 A1
(43) Pub. Date: Aug. 18, 2011

(54) Media Container File

(75) Inventors: Per Fröjdh, Stockholm (SE); Zhuangfei Wu, Solna (SE)

(73) Assignee: TELEFONAKTIEBOLAGET LM ERICSSON (PUBL), Stockholm (SE)

(21) Appl. No.: 13/122,851

(22) PCT Filed: Dec. 15, 2008
(86) PCT No.: PCT/SE2008/051460

§ 371 Date: Apr. 6, 2011

Related U.S. Application Data
(60) Provisional application No. 61/103,399, filed on Oct. 7, 2008.

(51) Int. Cl. G06F 7/00

(52) U.S. Cl. 707/803; 707/E17.028; 707/E17.044

(57) ABSTRACT

A media container file (30) is generated by organizing encoded video data representative of multiple camera views (22-28) of a video content as one or more video tracks (32) in the media container file (30). A view arrangement representation (34) indicative of a predefined deployment and position relation-ships of camera views (22-28) is selected among multiple different such predefined view arrangement representations. The view identifiers (36) of the multiple camera views (22-28) are included in the selected view arrangement representation (34). The view arrangement representation (34) with the included view identifiers (36) is organized in the media container file (30) relative the at least one video track (32).

### TECHNICAL FIELD

The present invention generally relates to multi-view video data, and in particular to a media container file comprising such multi-view video data.

### BACKGROUND

The ongoing standardization of Multi-View Video Coding (MVC) by Moving Picture Experts Group (MPEG) [1] and Telecommunication Standardization Sector (ITU-T) Study Group 16 (SG16) is a video coding technology which encodes video sequences produced by several cameras or a camera array. MVC exploits redundancy between the multiple video views in an efficient way to provide a compact encoded video stream. MVC is based on the Advanced Video Coding (AVC) standard, also known as ITU-T H.264, and consequently the MVC bit stream syntax and semantics have been kept similar to the AVC bit stream syntax and semantics.

ISO/IEC 14496-15 [2] is an international standard designed to contain Advanced Video Coding (AVC) bit stream information in a flexible and extensible format that facilitates management of the AVC bit stream. This standard is compatible with the MP4 File Format [3] and the 3GPP File Format [4]. All these standards are derived from the ISO Base Media File Format [5] defined by MPEG. The storage of MVC video streams is referred to as the MVC file format.

In the MVC file format, a multi-view video stream is represented by one or more video tracks in a file. Each track represents one or more views of the stream. The MVC file format comprises, in addition to the encoded multi-view video data itself, metadata to be used when processing the video data. For instance, each view has an associated view identifier implying that the MVC Network Abstraction Layer (NAL) units within one view have all the same view identifier, i.e. same value of the view_id fields in the MVC NAL unit header extensions.

Today camera parameters are stored in the Multiview acquisition information Supplementary Enhancement Information (SEI) message, which are contained in Extrinsic Camera Parameters Box and Intrinsic Camera Parameters Box. These parameters include translation vectors providing the position of the cameras and the coordinates of the camera focal lengths.

### SUMMARY

It is very hard and sometimes even impossible to determine relationships and overall deployment and layout of the cameras and camera views based on the information included today in the Multiview acquisition information SEI message.

The present embodiments overcome these and other drawbacks of the prior art arrangements.

It is a general objective to provide a generation of a media container file comprising valuable camera view deployment information.

This and other objectives are met by the embodiments as defined by the accompanying patent claims.

Briefly, an embodiment involves the generation of a media container file by organizing encoded video data representative of multiple camera views of a scene in at least one media track of the media container file. Multiple predefined view arrangement representations indicative of alternative predefined deployment and position relationships of camera views are available. The view arrangement representation or representations relevant for the current array of multiple camera views is selected. View identifiers of the multiple camera views are included in the selected view arrangement representation. This view arrangement representation with the view identifiers is associatively organized in the media container file relative the at least one media track.

The view arrangement representation provides high level information that directly lends an intuitive insight of how the cameras used for recording the multi-view data are arranged relative each other and gives any patterns in the camera deployment.

The embodiments also relate to a device for generating a media container file and such a media container file.

### SHORT DESCRIPTION OF THE DRAWINGS

The embodiments together with further objects and advantages thereof, may best be understood by making reference to the following description taken together with the accompanying drawings, in which:

FIG. 1 is a flow diagram of a method of generating a media container file according to an embodiment;

FIG. 2 is a schematic example of an array of multiple cameras and camera views;

FIG. 3 is another schematic example of an array of multiple camera views;

FIG. 4 is an illustration of an embodiment of a media container file;

FIG. 5 is an illustration of a box of multiple view arrangement representations that can be included in the media container file of FIG. 4;

FIG. 6 is a flow diagram illustrating an embodiment of the selecting and including steps of the generating method in FIG. 1;

FIGS. 7A and 7B illustrate examples of an inline view arrangement representation;

FIG. 8 is a flow diagram illustrating another embodiment of the selecting and including steps of the generating method in FIG. 1;

FIGS. 9A and 9B illustrate examples of a plane view arrangement representation;

FIG. 10 is a flow diagram illustrating an embodiment of the selecting step of the generating method in FIG. 1;

FIG. 11 illustrates an example of a rectangular view arrangement representation;

FIG. 12 is a flow diagram illustrating another embodiment of the selecting step of the generating method in FIG. 1;

FIGS. 13A and 13B illustrate examples of a sphere view arrangement representation;

FIG. 14 is a flow diagram illustrating yet another embodiment of the selecting step of the generating method in FIG. 1;

FIG. 15 illustrates an example of a stereo view arrangement representation;

FIG. 16 is a flow diagram illustrating optional, additional steps of the generating method in FIG. 1;

FIG. 17 illustrates an example of a representation overlapping camera views that can be included in the media container file of FIG. 4;

FIG. 18 is a schematic block diagram of a container file generating device according to an embodiment;

FIG. 19 is an overview of an example of communication system in which the embodiments can be implemented; and

FIG. 20 schematically illustrates overlapping camera views.

### DETAILED DESCRIPTION

Throughout the drawings, the same reference characters will be used for corresponding or similar elements.

The present embodiments are directed towards multi-view video data and a media container file comprising encoded multi-view video data.

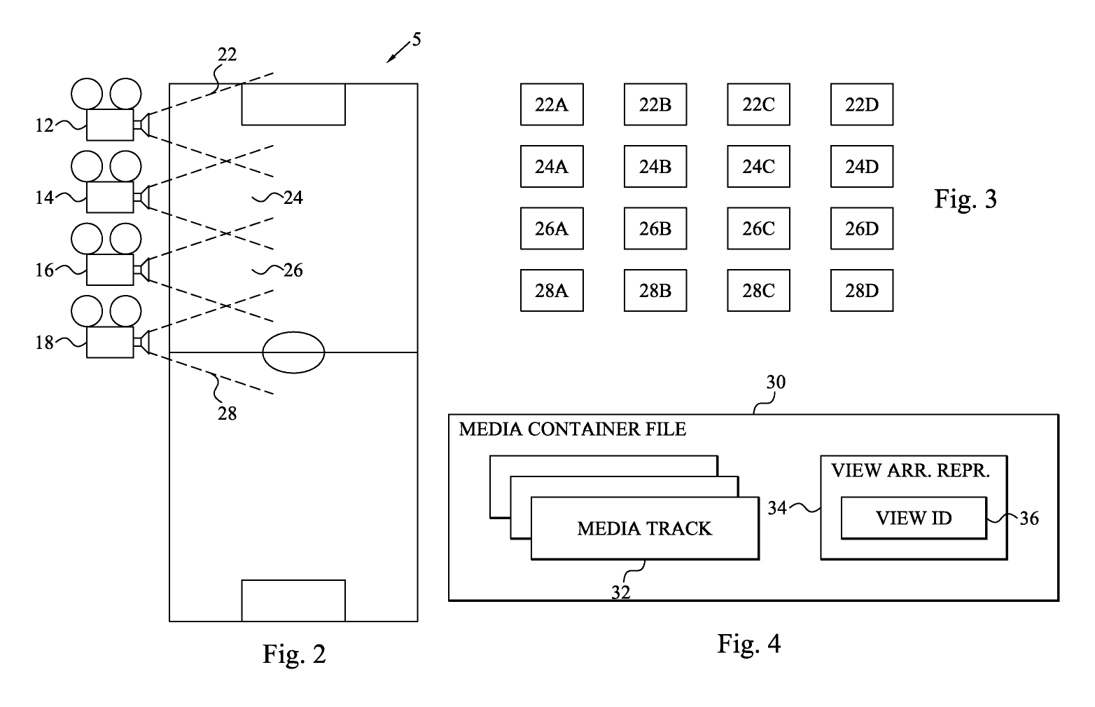

Multi-view video data implies that multiple camera views of a content are available, where each such camera view generates video data representative of the content but from one of multiple available camera views. In multi-view video, multiple cameras or other media recording/creating equipment or an array of multiple such cameras are provided relative a scene to record. As the cameras have different positions relative the scene and/or different pointing directions and/or focal lengths, they thereby provide alternative views for the content. FIG. 2 schematically illustrates this concept with an array 10 of multiple cameras 12-18 positioned next to a scene 5, e.g. a football field where a football match is to be recorded by the different cameras 12-18. The figure also indicates the respective camera views 22-28 of the cameras 12-18. The cameras 12-18 are, in this illustrative example, positioned at different positions along the length of the football field and therefore record different portions of the field. This means that the cameras 12-18 capture different versions of the media content as seen from their respective camera views 22-28.

As is well known in the art, video data encoding is typically based on relative pixel predictions, such as in H.261, H.263, MPEG-4 and H.264. In H.264 there are three pixel prediction methods utilized, namely intra, inter and bi-prediction. Intra prediction provides a spatial prediction of a current pixel block from previously decoded pixels of the current frame. Inter prediction gives a temporal prediction of the current pixel block using a corresponding but displaced pixel block in a previously decoded frame. Bi-directional prediction gives a weighted average of two inter predictions. Thus, intra frames do not depend on any previous frame in the video stream, whereas inter frames, including such inter frames with bi-directional prediction, use motion compensation from one or more other reference frames in the video stream.

Multi-view video coding has taken this prediction-based encoding one step further by not only allowing predictions between frames from a single camera view but also inter-view prediction. Thus, a reference frame can be a frame of a same relative time instance but belonging to another camera view as compared to a current frame to encode. A combination of inter-view and intra-view prediction is also possible thereby having multiple reference frames from different camera views.

In the art and as disclosed in the MVC standard draft [6], there is only a very limited amount of information included in the MVC file format of the positions of the cameras relative the recorded scene. Basically, the prior art information is limited to translation vectors and coordinates for the focal length of the cameras. However, this information does not per se provide any intuitive indication of, for instance, how the camera views are organized on a global basis, which camera views that are adjacent each other or indeed may be overlapping. In clear contrast, the vector and coordinate information for each camera must be fetched from the respective storage locations in media container file of the camera views. The fetched data is processed in a computationally complex algorithm in order to determine any global and local camera view interrelationships. For instance, it can be very hard and sometimes even impossible to decide, based on the vectors and coordinates, whether the cameras are organized in a grid on a plane or on a spherical surface.

The embodiments solve these limitations of the prior art by providing explicit information of view arrangement representations that can be fetched directly from the media container file and without any complex computations.

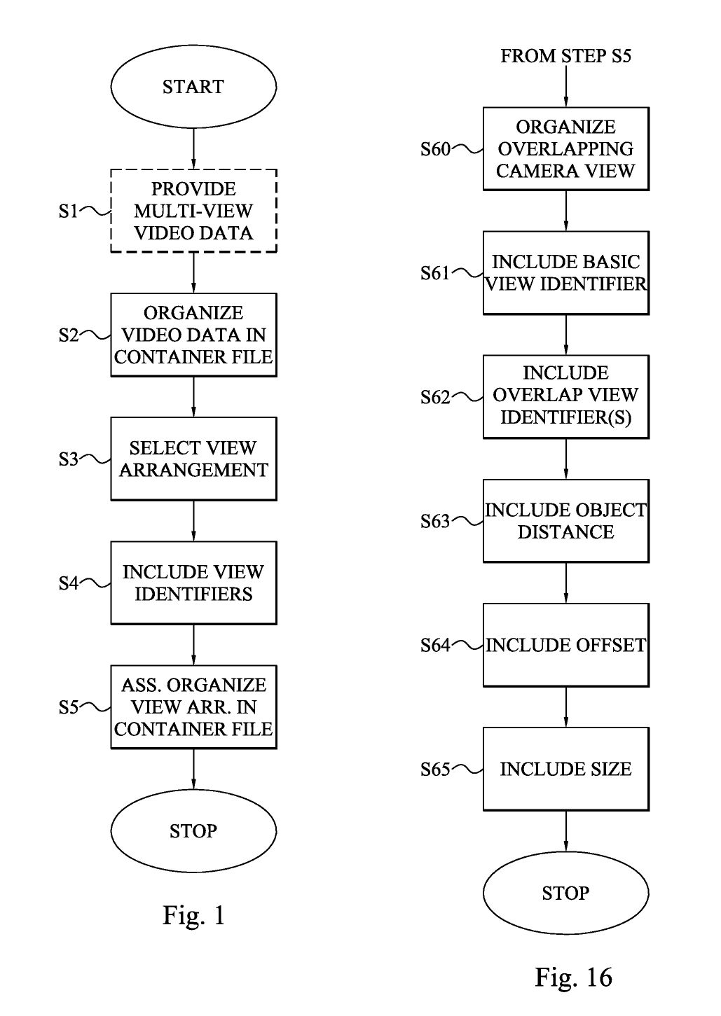

FIG. 1 is a flow diagram illustrating a method of generating a media container file according to an embodiment.

The method starts in step S1 where encoded video data representative of multiple camera views of a video content is provided. This multi-view video data provision of step S1 can be implemented by fetching the video data from an accessible media memory, in which the video data previously has been entered. Alternatively, the video data are received from some other external unit, where the video data has been stored, recorded or generated. A further possibility is to actually create and encode the video data, such as recording a video sequence or synthetically generating the video data.

The provided encoded multi-view video data is organized as at least one media track of a media container file in a next step S2. The media container file can, for instance, be a so-called MVC file or some other file format that is preferably based on the ISO Base Media File Format.

The media container file can be regarded as a complete input package that is used by a media server during a media session for providing video content and forming video data into transmittable data packets. Thus, the container file preferably comprises, in addition to the video content per se, information and instructions required by the media server for performing the processing and allowing transmission of the video content during a media session.

In an embodiment, each camera view has a separate assigned media track of the media container file, thereby providing a one-to-one relationship between the number of camera views and the number of media tracks. Alternatively, the encoded video data of at least two, possibly all, camera views can be housed in a single media track of the media container file. FIG. 4 schematically illustrates an example of a media container file 30 having one or more media tracks 32 carrying the encoded multi-view video data.

The respective video data of the multiple camera views, irrespective of being organized into one or more media tracks, is preferably assigned respective view identifiers associated with the camera views.

The next step S3 of the generating method selects a view arrangement representation for the multi-view video data based on the relative positions of the multiple camera views. This view arrangement representation is further selected among multiple predefined view arrangement representations. These view arrangement representations are indicative of different predefined deployment and position relationships of the multiple camera views. The view arrangement representation can be regarded as an identifier of the particular overall deployment of the multiple cameras and camera views relative the recorded scene. The view arrangement representation therefore directly provides information of how the multiple camera views are organized and does not require any processing of camera vectors and coordinate in order to determine the current camera view deployment.

Step S3 selects the view arrangement from a set of multiple predefined view arrangement representations. This means that there is a limited number of, in advance specified and allowed, deployments, in which cameras can be organized relative a scene or object to be recorded in a multi-view setting. These predefined view arrangement representations correspond to the most usual deployment plans of cameras that are used in multi-video recording.

Examples of such predefined view arrangement representations that could be used include an inline view arrangement representation, a plane view arrangement representation, a rectangular view array representation, a sphere view array arrangement representation and a stereo view pair arrangement representation. The set of multiple predefined view arrangement representations can therefore include all of the above mentioned view arrangement representations or a subset thereof as long as there is multiple, i.e. at least two, predefined view arrangement representations in the set. The present embodiments are, though, not limited to these particular view arrangement representations but can alternatively or in addition use other view arrangement representations having different camera view deployments besides in a straight line, in a plane, in a rectangular lattice, on a sphere or as a stereo view pair.

The selection of step S3 can be performed by selecting a single view arrangement representation. Alternatively, a subset of the multiple predefined view arrangement representations may indeed apply to a current camera view arrangement and may therefore be selected in step S3. For instance, camera views deployed as defined by the rectangular view array arrangement representation are also deployed in a plane, thereby also the plane view arrangement representation could be selected.

View identifiers of the multiple camera views are included in the selected view arrangement representation in step S4. Thus, these view identifiers specify which camera views that are deployed relative the recorded scene according to the deployment plan indicated by the selected view arrangement representation. The view identifiers are preferably included in the view arrangement representation in the order describing the relative position order of the camera views in the deployment and position relationship defined by the selected view arrangement representation. Thus, the view identifiers of the camera views are preferably included in the view arrangement in the order at which the camera views were positions relative the scene in the deployment plan defined by the view arrangement representation.

The selected view arrangement with the included view identifiers is associatively organized in the media container file in step S5 relative the at least one media track organized into the file in step S2. Associatively organize implies that the view arrangement representation is included in the media container file in such a way as to provide an association between the view arrangement representation and the camera views to which the view arrangement representation applies. Correspondingly, such an association can instead be between the view arrangement representation and the encoded multi-view data organized into the at least one media track.

The association can be in the form of a pointer from the storage location of the video data within the media container file to the storage location of the view arrangement representation, or vice versa. This pointer or metadata therefore enables, given the particular video data or its location within the media container file, identification of the associated view arrangement representation or the storage location of the view arrangement representation within the file. Instead of employing a pointer, the metadata can include a video data identifier of the video data or a track identifier of the media track carrying the multi-view video data. Further examples include the view identifiers included in the view arrangement representation, which allows identification of the camera views and therefore the video data and the media tracks to which the view arrangement representation applies.

The method then ends. The operation steps of the generating method may be conducted in serial order as illustrated in FIG. 1. Alternatively, the steps S3 to S5 can be conducted prior to or indeed parallel with the steps S1 and S2.

FIG. 4 schematically illustrates an embodiment of the media container file 30. The media container file 30 comprises one or more media tracks 32 carrying the encoded multi-view video data. The selected view arrangement representation 34 comprising view identifiers 36 of the camera views is also organized as metadata in the media container file 30.

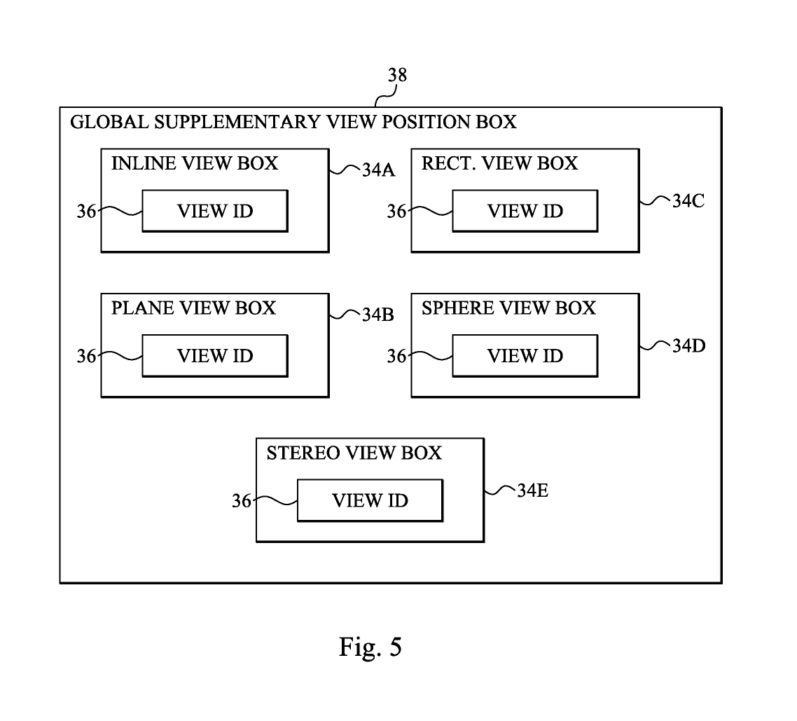

FIG. 5 illustrates an example of how the view arrangement representation can be organized in the media container file. In this illustrative example, the media container file comprises a box denoted Global Supplementary View Position Box 38. This box 38 documents commonly used camera positions. This is particularly useful when the cameras and camera views are oriented in an intuitively simple pattern, which may be complicated to extract from camera position coordinates. A content creator can use this box to highlight useful relationships between cameras of his or her choice.

The global supplementary view position box 38 of FIG. 5 illustrates the multiple predefined view arrangement representations 34A to 34E according to an embodiment. Thus, the box 38 comprises an inline view box 34A, a plane view box 34B, a rectangular view box 34C, a sphere view box 34D and a stereo view box 34E. Note that in most practical implementations only one or a subset of the view arrangement representations 34A to 34E are indeed included in the global supplementary view position box 38 as this or these subsets are selected for the current camera view arrangement.

A non-limiting example of providing the global supplementary view position box 38 in the media container file could be as:

| | |
|---|---|
| Box Types: | ‘gsvp’ |
| Container: | Movie Box (‘moov’) |
| Mandatory: | No |
| Quantity: | Exactly one |

| aligned(8) class GlobalSupplementaryViewPositionBox | |
|---|---|
| extends Fullbox(‘gsvp’, version = 0, 0) { | |
| InlineViewBox( ); | //optional |
| PlaneViewBox( ); | //optional |
| RectangularViewBox( ); | //optional |
| SphereViewBox( ); | //optional |
| StereoViewBox( ); | //optional |
| } | |

The view boxes 34A to 34E available for the box type ‘gsvp’ are optional, implying that not all of them must necessarily be included in the media container file for a given camera view arrangement. In FIG. 5, the box 38 is illustrated as having at most one box 34A to 34E per view arrangement representation type. However, for some camera arrays it could be advantageously to include multiple view arrangement representations of a given type, such as multiple inline view arrangement representations 34A and/or multiple stereo view arrangement representations 34E.

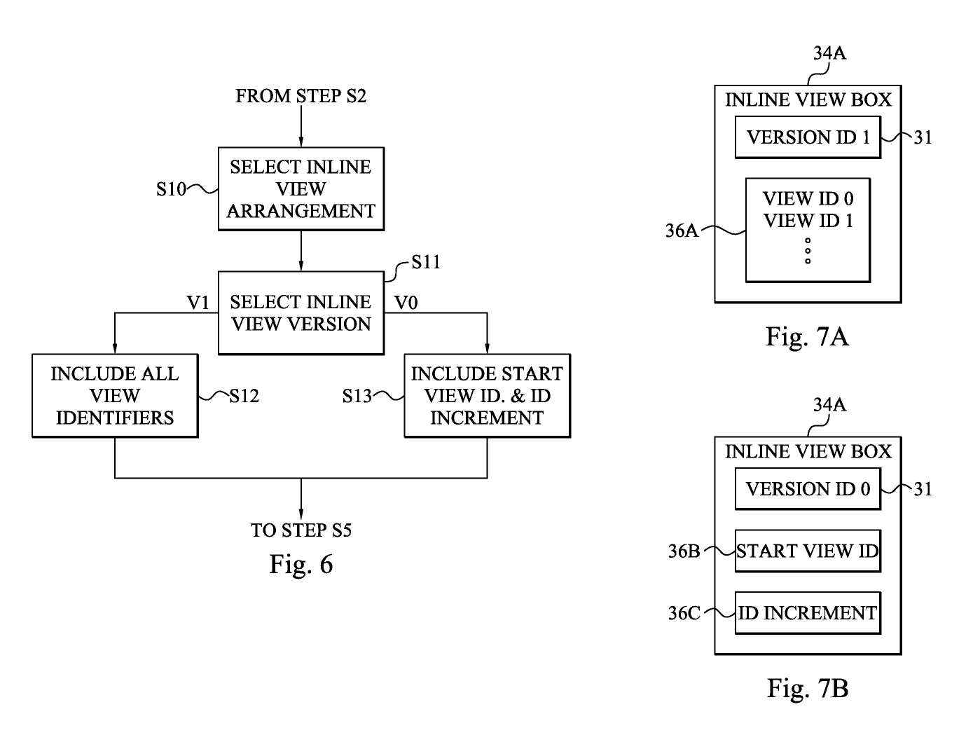

FIG. 6 is a flow diagram illustrating an embodiment of the selecting step S3 and including step S4 of the generating method in FIG. 1. The method continues from step S2 of FIG. 1. A next step S10 selects, based on the relative positions of the multiple camera views or multiple cameras, an inline view arrangement representation. For instance and with reference to FIG. 2, the camera views 22-28 are all arranged in a straight line and the inline view arrangement representation should be selected for this camera view deployment.

FIG. 3 illustrates another group of camera views. In this case there are actually 34 possible entries of the inline view arrangement representation for the array with 16 camera views 22A to 28D if the minimum number of camera views is three:

| | | |
|---|---|---|
| 22A, 22B, 22C, 22D | 24A, 24B, 24C, 24D | 26A, 26B, 26C, 26D |
| 28A, 28B, 28C, 28D | 22A, 24A, 26A, 28A | 22B, 24B, 26B, 28B |
| 22C, 24C, 26C, 28C | 22D, 24D, 26D, 28D | 22A, 24B, 26C, 28D |
| 28A, 26B, 24C, 22D | 24A, 26B, 28C | 22A, 24B, 26C |
| 24B, 26C, 28D | 22B, 24C, 26D | 26A, 24B, 22C |
| 28A, 26B, 24C | 26B, 24C, 22D | 28B, 26C, 24D |
| 22A, 22B, 22C | 22B, 22C, 22D | 24A, 24B, 24C |
| 24B, 24C, 24D | 26A, 26B, 26C | 26B, 26C, 26D |
| 28A, 28B, 28C | 28B, 28C, 28D | 22A, 24A, 26A |
| 24A, 26A, 28A | 22B, 24B, 26B | 24B, 26B, 28B |
| 22C, 24C, 26C | 24C, 26C, 28C | 22D, 24D, 26D |
| 24D, 26D, 28D | | |

In a preferred embodiment, the number of camera views regarded as being in a straight line is at least 3 as in the example above.

An optional next step S11 selects an inline version of a first inline version and a second inline version. These multiple inline versions define different ways of organizing view identifiers of the, preferably, at least three camera views deployed in a straight line. The selection of inline version in step S11 is performed based on the relative positions of the multiple camera views. If the first inline version, V1, is selected in step S11 the method continues to step S12. Step S12 includes, in the inline view arrangement representation, all the view identifiers of the camera views deployed in the straight line. Thus, camera views are provided in the correct order as they are deployed along the line. For instance, 22A, 24B, 26C, 28D in FIG. 3 if 22A to 28D represents the view identifiers for the camera views.

If, however, the second inline version, V0, is selected in step S11, step S13 includes a start_view_identifier and optionally an identifier increment in the inline view arrangement representation. This way of representing the view identifiers will be more efficient in terms of the total bit size of the view identifiers. However, the second inline version is only available if the camera views are organized in such a way that their view identifiers will be as start_view_id, start_view_id+id_increment, start_view_id+2×id_increment, start_view_id+3×id_increment, . . . , where start_view_id is the view identifier of the camera view with the lowest view identifier among the series of aligned camera views and id_increment is the identifier increment. In some applications the identifier increment can have a predefined value, such as one, thereby relaxing the need of specifying any identifier increment in the inline view box. The method then continues to step S5 of FIG. 1.

FIG. 7A illustrates a first example of the inline view box 34A if the first inline version was selected in step S11 of FIG. 6. The inline view box 34A comprises the version identifier 31 having a value associated with the first inline version. View identifiers 36A of the aligned camera views are also included in the inline view box 34A.

FIG. 7B illustrates the corresponding inline view box 34A if the second inline version was instead selected in step S11 of FIG. 6. The inline view box 34A comprises the inline version identifier 31, the start_view identifier 36B and the optional identifier increment 36C mentioned above. The start_view identifier 36B and the identifier increment 36C are representations of the view identifiers of the aligned camera views and can be used for calculating the camera views according to view_idₖ=start_view_id+k×id_increment, where k=0, 1, 2, . . . , view_count−1 and view_count is an integer that specifies the number of consecutively aligned camera views.

Although not illustrated in FIGS. 7A and 7B, the inline view box 34A could also comprises the view_count, i.e. the total number of camera views aligned in the straight line. This is though not necessary because the size field contained in the box/fullbox structure gives out the indication how many view entries are in the box. One can always divide the size by the number of bits occupied by each view to obtain total number of views.

The inline view box 34A can be defined as:

| | |
|---|---|
| Box Types: | ‘ilvi’ |
| Container: | Global Supplementary View Position Box (‘gsvp’) |
| Mandatory: | No |
| Quantity: | zero or more |

| aligned(8) class InlineViewBox extends Fullbox(‘ilvi’, version, 0) { | |
|---|---|
| if (version == 1) { | |
| for (i=0; ; i++) { | //to end of box |

| | |
|---|---|
| unsigned int(6) | reserved1 = 0; |
| unsigned int(10) | view_id; |
| } | |
| } else { | |
| unsigned int(6) | reserved2 = 0; |
| unsigned int(10) | start_view_id; |
| unsigned int(16) | view_count; |
| unsigned int(16) | id_increment |
| } | |
| } | |

### Semantics

version is an integer specifying the inline version of the inline view box.

view_id is the identifier of the camera view as indicted in ViewIdentifier Box in document [6].

start_view_id is the view identifier of the camera view as indicated in ViewIdentifierBox, which is the lowest view_id among the series of aligned camera views.

view_count is an integer that counts the number of consecutive aligned camera views.

id_increment is the identifier increment.

Note that a single camera view arrangement may comprise multiple inline view boxes as indicated above and discussed in connection with FIG. 3.

In an alternative embodiment only the first inline version is available. Thus, steps S11 and S13 can be omitted and all inline view boxes are as illustrated in FIG. 7A. A further alternative is to only allow the second inline version. Steps S11 and S12 can therefore be omitted and the inline view boxes are as illustrated in FIG. 7B.

In other embodiments, the inline view arrangement representation also comprises information indicating whether the straight line of aligned camera views is a horizontal line, a vertical line or an oblique line.

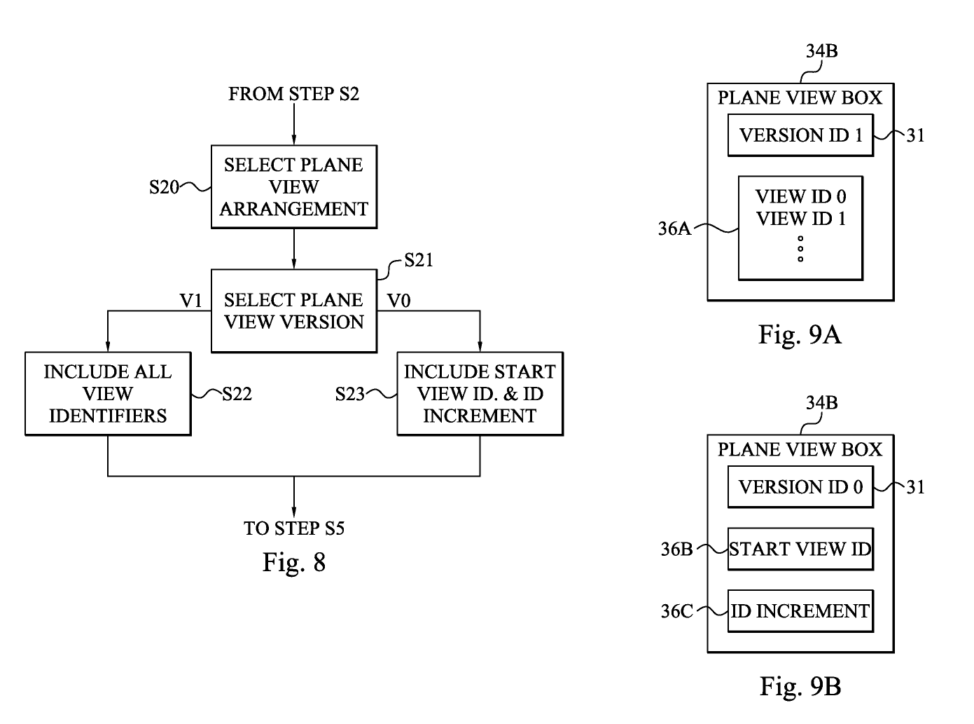

FIG. 8 is a flow diagram illustrating an embodiment of the selecting step S3 and the including step S4 in FIG. 1. The method continues from step S2 of FIG. 1. A next step S20 selects, based on the relative positions of the multiple camera views, a plane view arrangement representation. This view arrangement representation is selected if the group of camera views or cameras is located on a plane. The number of camera views in the group is preferably no less than three. All camera views 22A to 28D illustrated in FIG. 3 lie on a plane and the plane view arrangement representation can therefore be selected for the group of camera views 22A to 28D.

A next optional step S21 selects between a first plane view version and a second plane view version in correspondence to the case with inline view arrangement representation. The selection of step S21 is performed based on the relative positions of the multiple camera views. If the first plane version, V1, is selected in step S21, step S22 includes, in the plane view arrangement representation, all the view identifiers of the camera views aligned in the plane. This step S22 is basically conducted as step S12 of FIG. 6 with the exception that the multiple camera views are aligned in a plane and not only on a straight line. The view identifiers are preferably included in the order obtained by traveling through the camera views in the plane according to a predefined scanning scheme, such as starting from the upper left camera view and then scanning along the first row and then continuing with the second row and so on. Other possible scanning orders that can be used include a zigzag scanning order. This then means that a matrix comprising, for instance, 3×3 cameras or camera views could be scanned in the order (1,1), (1,2), (2,1), (3,1), (2,2), (1,3), (2,3), (3,2) and (3,3) with (row, column). A further example is an interlaced scanning order.

If the second plane version, V0, is instead selected in step S22, step S23 includes a start_view_identifier and, optionally and unless being fixed, an identifier increment in the plane view arrangement representation. This step S23 is basically conducted as step S13 of FIG. 6. The method then continues to step S5 of FIG. 1.

FIG. 9A illustrates the plane view box 34B, i.e. plane view arrangement representation, for the first plane version. The plane view box 34B comprises the version identifier 31 and all the view identifiers 36A of the camera views aligned in the plane. FIG. 9B illustrates the plane view box 34B if the version identifier 31 signals the second plane version. The plane view box 34B then comprises the start_view_identifier 36B and optionally the identifier increment 36C. The plane view box 34B optionally comprises information, i.e. view_count, of the number of camera views aligned in the plane.

In similarity to the inline view arrangement representation, in an alternative embodiment only the first plane version is available or only the second plane version.

The plane view box could be defined as:

| | |
|---|---|
| Box Types: | ‘plvi’ |
| Container: | Global Supplementary View Position Box (‘gsvp’) |
| Mandatory: | No |
| Quantity: | zero or more |

| aligned(8) class PlaneViewBox extends FullBox(’plvi’, version, 0) { | |
|---|---|
| if (version == 1) { | |
| for (i=0; ; i++) { | //to end of box |

| | |
|---|---|
| unsigned int(6) | reserved1 = 0; |
| unsigned int(10) | view_id; |
| } | |
| } else { | |
| unsigned int(6) | reserved2 = 0; |
| unsigned int(10) | start_view_id; |
| unsigned int(16) | view_count; |
| unsigned int(16) | id_increment; |
| } | |
| } | |

### Semantics

version is an integer specifying the plane version of the plane view box.

view_id is the identifier of the camera view as indicted in ViewIdentifier Box in document [6].

start_view_id is the view identifier of the camera view as indicated in ViewIdentifierBox, which is the lowest view_id among the series of consecutive camera views located on a plane.

view_count is an integer that counts the number of consecutive aligned camera views on the plane.

id_increment is the identifier increment

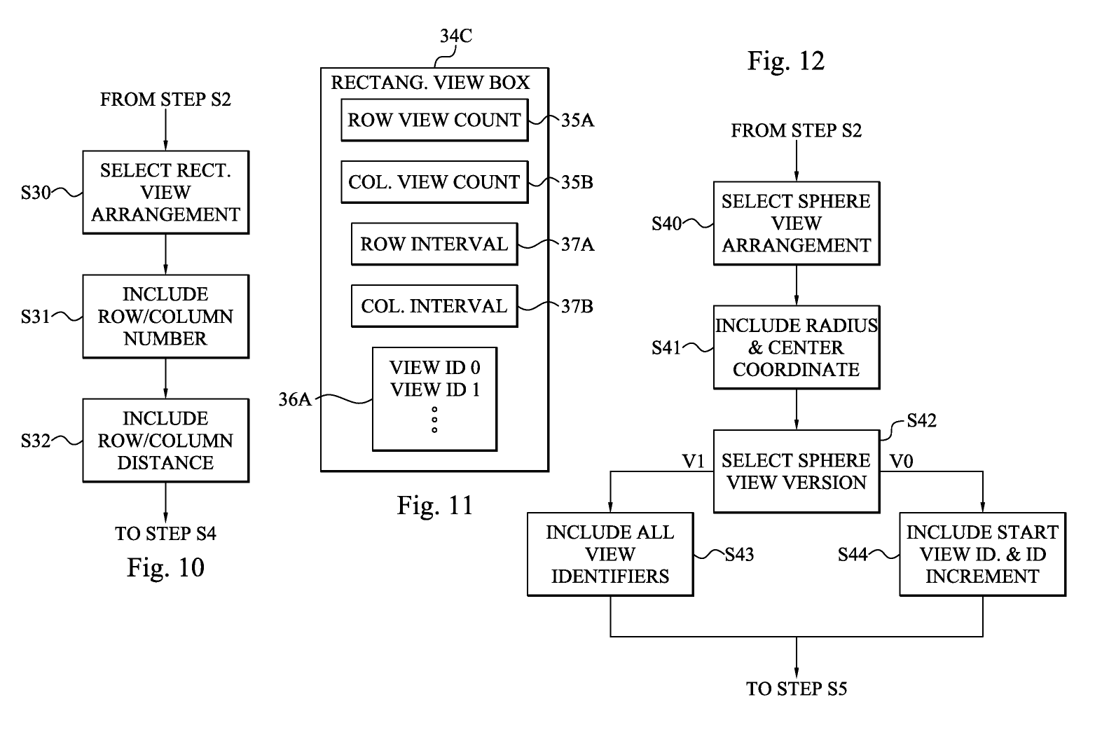

FIG. 10 is a flow diagram illustrating an embodiment of the selecting step S3 of FIG. 1. The method continues from step S2 in FIG. 1. A next step S30 selects a rectangular view array arrangement based on the relative positions of the multiple camera views. Such a rectangular view arrangement representation is suitable for representing a group of camera views or cameras which form a rectangular lattice or grid on a plane. The number of camera views in the group is preferably no less than four and are preferably equally spaced in a periodic pattern. FIG. 3 illustrates a group of camera views 22A to 28D is arranged in a rectangular array.

A next step S31 includes, in the plane view array arrangement representation, a representation of the number of row and a representation of the number of columns of the rectangular camera view array. Representations of the distance between consecutive rows and consecutive columns in the rectangular camera view arrays are determined and included in the rectangular view array arrangement representation in step S32. The method continues to step S4 of FIG. 1, where the view identifiers of the camera views in the rectangular arrays are included in the arrangement representation. The view identifiers are preferably included in the order as determined by the above-mentioned scanning scheme.

FIG. 11 is a schematic illustration of a rectangular view box 34C, i.e. rectangular view array arrangement representation, according to an embodiment. The rectangular view box 34C comprises the representations 35A, 35B of the number of rows and columns in the rectangular array and the representations 37A, 37B of the distance between consecutive rows and consecutive columns. The view identifiers 36A of the camera views organized in the rectangular array are also included in the rectangular view box 34C.

A selection between two rectangular versions in similarity to the inline and plane view boxes could alternatively be used also for the rectangular view box 34C. Furthermore, instead of explicitly listing all the view identifiers 36A of the camera views, a start_view_identifier and optionally identifier increment may be used to provide an implicit listing of the view identifiers.

The rectangular view box 34C can be represented in the media container file as:

| | |
|---|---|
| Box Types: | ‘rtvi’ |
| Container: | Global Supplementary View Position Box (‘gsvp’) |
| Mandatory: | No |
| Quantity: | zero or more |

| aligned(8) class RectangularViewBox extends Box(‘rtvi’) { | |
|---|---|
| unsigned int(32) row_view_count; | |
| unsigned int(32) row_interval; | |
| unsigned int(32) column_view_count; | |
| unsigned int(32) column_interval; | |
| for (i=0; i<row_view_count; i++) { | |
| for (j=0; j<column_view_count; j++) { | |
| unsigned int (6) | reserved = 0; |
| unsigned int(10) | view_id[i][j]; |
| } | |
| } | |
| } | |

### Semantics

row_view_count specifies the number of row in the rectangular array.

row_interval denotes the distance between two rows in the rectangular array.

column_view_count is the number of columns in the rectangular array.

column_interval specifies the distance between two columns in the rectangular array.

view_id [i] [j] is the identifier of the camera view as indicted in ViewIdentifier Box in document [6].

FIG. 12 is a flow diagram illustrating an embodiment of the selecting step S3 and the including step S4 of FIG. 1. The method continues from step S2 in FIG. 1. A next step S40 selects a sphere view arrangement representation based on the relative positions of the multiple camera views. This arrangement representation is available for a group of camera views or cameras located on a spherical surface. The camera views may, for instance, be provided along the circumference of the sphere, i.e. basically being positioned along the edge of a circle centered at the center of the sphere and having the same radius. Also more elaborated embodiments, where camera views are located over a portion of the spherical surface are also possible. Generally, the number of camera views is preferably no less than four.

The next step S41 of FIG. 12 includes information of the radius and the center coordinates of the sphere in the sphere view arrangement representation. In an optional embodiment, two sphere view versions are available as for the inline and plane view arrangement representations. Step S42 selects the sphere version view to use for the current group of camera views based on the relative positions of the camera views. If a first sphere view version is selected, all view identifiers of the camera views in the groups are explicitly included in the sphere view arrangement representation in step S43. However, if the second sphere view version is instead selected, a start view identifier and optionally an identifier increment are included in addition to information of the total number of camera views in the group.

The method thereafter continues to step S5 of FIG. 1.

In alternative embodiments only one of the first sphere version and the second sphere version is available.

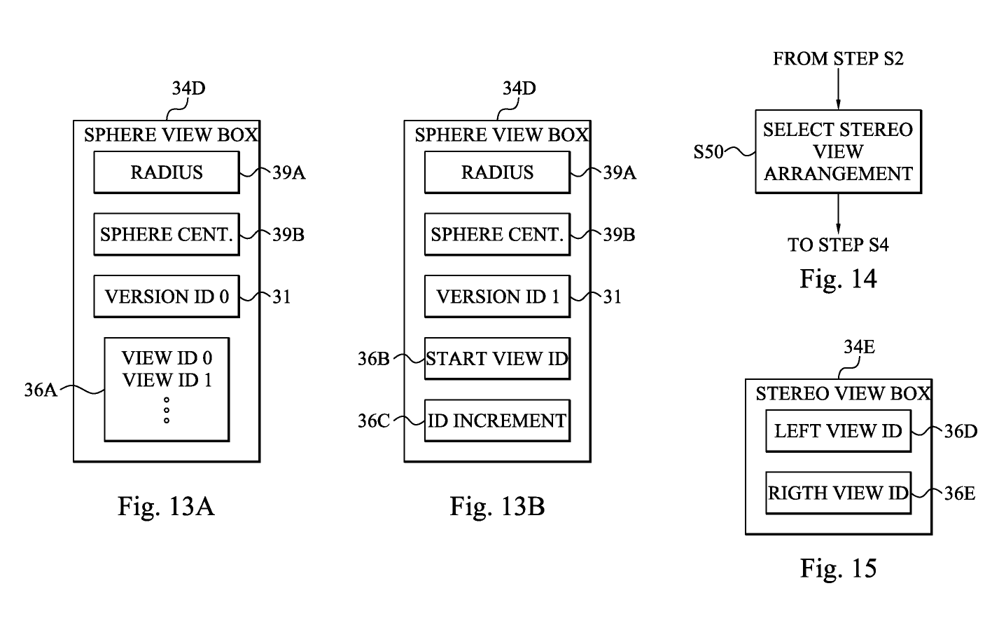

FIG. 13A illustrates the sphere view box 34D according to the first sphere version. The sphere view box 34D comprises information of the radius 39A and of the coordinates of the center of the sphere 39B in addition to the sphere version identifier 31. The camera views 36A are explicitly listed in the sphere view box in this sphere version.

FIG. 13B illustrates the sphere view box 34D according to the second sphere version. Instead of the explicitly listed view identifiers, the sphere view box 34D comprises the start_view_identifier 36B and optionally the identifier increment unless it is fixed, such as one or some other integer.

The sphere view box may be defined in the media container file as follows:

| | |
|---|---|
| Box Types: | ‘spvi’ |
| Container: | Global Supplementary Position Box (‘gsvp’) |
| Mandatory: | No |
| Quantity: | zero or more |

| aligned(8) class SphereViewBox extends FullBox(‘spvi’) { | |
|---|---|
| unsigned int(32) | radius; |

| unsigned int(32) center_of_sphere[3]; | |
|---|---|
| if (version == 1) { | |
| for (i=0; ; i++) { | //to end of box |

| | |
|---|---|
| unsigned int(6) | reserved1 = 0; |
| unsigned int(10) | view_id; |
| } | |
| } else { | |
| unsigned int(6) | reserved2 = 0; |
| unsigned int(10) | start_view_id; |
| unsigned int(16) | view_count; |
| unsigned int(16) | id_increment; |
| } | |
| } | |

### Semantics

version is an integer specifying the sphere version of the sphere view box.

radius specifies the radius of the sphere in the sphere view array arrangement.

center_of_sphere is the center point coordinate of the sphere.

view_id is the identifier of the camera view as indicted in ViewIdentifier Box in document [6].

start_view_id is the view identifier of the camera view as indicated in ViewIdentifierBox, which is the lowest view_id among the series of consecutive camera views located on a spherical surface.

view_count is an integer that counts the number of consecutive aligned camera views on the spherical surface.

id_increment is the identifier increment

FIG. 14 is a flow diagram illustrating an embodiment of the selecting step S3 of FIG. 1. The method continues from step S2 in FIG. 1. Step S50 selects a stereo view arrangement representation based on the relative positions of the multiple camera views. This stereo view arrangement indicates a pair of camera views which can be used to render three dimensional (3D) video. The camera views therefore preferably have the distance of the human left eye and the right eye and the focusing angles that are suitable for the human visual system.

The method continues from step S50 to step S4 in FIG. 1, where the view identifiers of the left camera view and the right camera view are included in the stereo view arrangement representation.

FIG. 15 schematically illustrates an embodiment of a stereo view box 34E, i.e. the stereo view arrangement representation. The stereo view box comprises the above-mentioned identifiers 36D, 36E of the left and right camera views forming the stereo view pair.

The stereo view box 34E can be implemented as:

| | |
|---|---|
| Box Types: | ‘stvi’ |
| Container: | Global Supplementary View Position Box (‘gsvp’) |
| Mandatory: | No |
| Quantity: | zero or more |

| aligned(8) class StereoViewBox extends Box(‘stvi’) { | |
|---|---|
| unsigned int(6) | reserved1 = 0; |
| unsigned int(10) | left_view_id; |
| unsigned int(6) | reserved2 = 0; |
| unsigned int(10) | right_view_id; |
| } | |

### Semantics

left_view_id is the view identifier of the camera view as indicated in ViewIdentifierBox in document [6] and which can be used as left eye view. right_view_id is the corresponding view identifier that can be used as right eye view.

A given group of multiple camera views can be assigned multiple view arrangement representations as discussed above. In such a case, the multiple view arrangement representations may be of a same type or of different types. For instance, the camera view deployment illustrated in FIG. 3 could potentially be assigned 34 different inline view arrangement representations, a plane view arrangement representations, a rectangular view arrangement representations and possibly one or more stereo view arrangement representations.

Thus, the definitions of the predefined view arrangement representations discussed above are not exclusive. For instance, a rectangular view arrangement is also a plane view arrangement but not necessarily the other way around. It is up to the content provider, creating the media container file, to specify the view arrangement or view arrangements that he or she thinks are the most important or relevant for the current camera view arrangement. The content creator may further select the type of view arrangement representation or representations to select based on the particular scene recorded by the multiple cameras. For instance, in a news narrator scene, a sphere view arrangement could be advantageously. Correspondingly, in track racing, such as a 100 meter race, an inline view arrangement is a good choice, while plane and rectangular view arrangements may be used in broad scene captures, such as in battles or Olympic ceremonies.

In addition to the view arrangement representation selected for representing the global arrangement of the multiple camera views used for generating the multi-view video data included in the media container file, the media container file may also contain information describing local relationships of the camera views. Examples of such local relationships is specifying adjacent views, i.e. the nearest camera view in relation to the current camera view in distance, and overlapping views, i.e. camera views which have overlapping content areas.

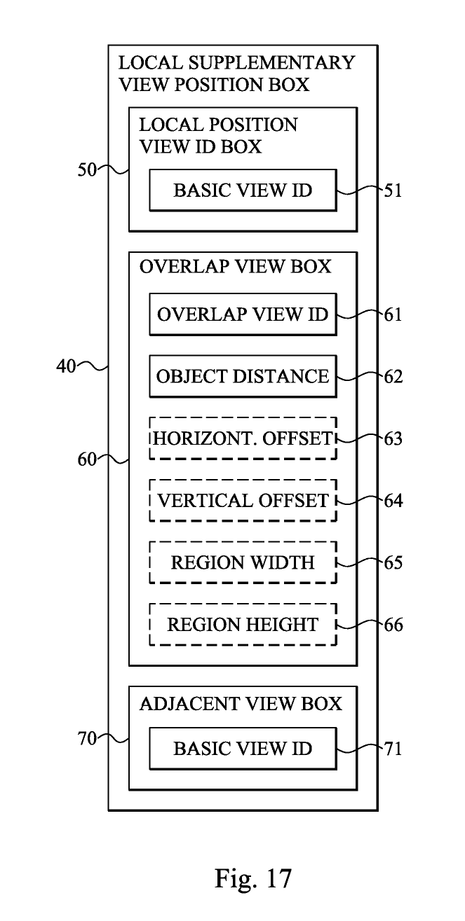

In such a case, the media container file may comprise a so-called local supplementary view position box 40 as is illustrated in FIG. 17. The local supplementary view position box 40 can be implemented in the media container file as:

| | |
|---|---|
| Box Types: | ‘lsvp’ |
| Container: | Local Supplementary View Position Container Box (‘lvpc’) |
| Mandatory: | No |
| Quantity: | zero or more |

aligned(8) class LocalSupplementaryViewPositionBox
extends FullBox(‘lsvp’, version = 0, 0) {

| | |
|---|---|
| LocalPosistionViewIdentifierBox( ); | //mandatory |
| AdjacentViewBox( ); | //optional |
| OverlapViewBox( ); | //optional |
| } | |

In this illustrative example, the local supplementary view position box 40 is provided in a local supplementary view position container box arranged in the media container file. The local supplementary view position container box can be implemented as:

| | |
|---|---|
| Box Types: | ‘lvpc’ |
| Container: | Sample Entry (‘avc1’, ‘avc2’, ‘mvc1’) |
| Mandatory: | No |
| Quantity: | Zero or one |

aligned(8) class LocalSupplementaryViewPositionContainerBox
extends FullBox(‘lsvp’, version = 0, 0) {
LocalSupplementaryViewPositionBox( ); //optional
}

Alternatively, the local supplementary view position container box may be omitted.

The local supplementary view position box 40 comprises a local position view identifier box 50 that specifies the view identifier 51 of one of the camera views that is regarded as the basic view. The local supplementary view position box 50 can therefore be implemented as:

| | |
|---|---|
| Box Types: | ‘lpvi’ |
| Container: | Local Supplementary View Position Box (‘lsvp’) |
| Mandatory: | Yes |
| Quantity: | Exactly one |

aligned(8) class LocalPositionViewIdentifierBox extends Box(‘lpvi’) {

| | |
|---|---|
| unsigned int(6) | reserved = 0; |
| unsigned int(10) | view_id; |
| } | |

### Semantics

view_id is the view identifier of the camera view whose adjacent and/or overlap information may be provided by other boxes which are contained in local supplementary view position box.

The optional adjacent view box 70 comprises the view identifier or identifiers 71 of the camera view or views being closest in terms of distance relative the basic camera view identified in the local position view identifier box 50. The adjacent view box 70 may be implemented as:

| | |
|---|---|
| Box Types: | ‘advi’ |
| Container: | Local Supplementary View Position Box (‘lsvp’) |
| Mandatory: | No |
| Quantity: | Zero or one |

| aligned(8) class AdjacentViewBox extends Box(‘advi’) { | |
|---|---|
| for (i=0; ; i++) { | //to end of box |

| | |
|---|---|
| unsigned int(6) | reserved = 0; |
| unsigned int(10) | view_id; |
| } | |
| } | |

### Semantics

view_id is the view identifier of the camera view which is adjacent the camera view identified in the local position view identifier box 50.

The adjacent view is a physical position definition of nearby located cameras. It is related to the position of the cameras but does not regard what scene or objects the cameras are shooting at. As long as two cameras of a group of more than two cameras are the closest in distance, they can be categorized into adjacent camera even though they might be shooting at different, even opposite, directions.

In clear contrast to the adjacent view, overlap view is a content-wise representation that defines that the camera views of at least two cameras are overlapping at least partly. In such an embodiment, a representation of overlapping camera views is organized in the media container file.

FIG. 16 is a flow diagram illustrating an embodiment of providing such overlap view representation. The method continues from step S5 in FIG. 1. With reference to FIGS. 16 and 17, a next step S60 associatively organizes the representation 40 of overlapping camera views in the media container file relative the at least one media track. The view identifier 51 of the camera view selected as basic view identifier is included in the representation 40 of overlapping camera views in step S61, preferably by being included in the local position view identifier box 50.

The view identifier or identifiers 61 of the camera view or views that overlap at least partly with the basic camera view is or are included in the representation 40 in step S62. In FIG. 2, if the camera view 22 is selected as the basic camera view, the camera view 24 will be an overlapping camera view. Correspondingly, if instead the camera view 24 is the basic camera view, both camera view 22 and camera view 26 will be overlapping views.

The distance between the object or scene and the shooting cameras will result in different overlap areas. For example, two cameras might record a police officer. If the police officer stands close in front of the two cameras, then it could be that the left camera captures the left arm and the right camera captures the right arm. In such a case, there is no overlapping area between the two camera views. If the police officer instead stands further away, both cameras can capture the entire image of the police officer and consequently the areas on the camera screen where the police officer stands belong to the overlap area.

As a consequence, an object distance 62 specifying the distance between the cameras and the common interested object is preferably determined and included in step S63 in the representation 40.

With reference to FIGS. 16, 17 and 20, in order to define how the overlapping view 24 is overlapping the basic camera view 22, offset information 63, 64 specifying a horizontal offset 83 and a vertical offset 84, respectively, is included in the representation 40 in step S64. The size of the overlapping region is defined by size information 65, 66, preferably the width 85 and the height 86 of the overlapping region. This size information 65, 66 is included in step S65 in the representation 40.

In FIG. 17, the information relating to overlapping regions and camera views are provided in an overlap view box 60 included in the local supplementary view position box 40. The overlap view box 60 can be implemented as:

| | |
|---|---|
| Box Types: | ‘olvi’ |
| Container: | Local Supplementary View Position Box (‘lsvp’) |
| Mandatory: | No |
| Quantity: | zero or more |

| aligned(8) class OverlapViewBox extends Box(‘spvi’) { | |
|---|---|
| unsigned int(6) | reserved = 0; |
| unsigned int(10) | view_id; |
| unsigned int(1) | dynamic_overlap; |
| unsigned int(7) | reserved = 0; |
| unsigned int(32) | object_distance; |

| if (dynamic overlap == 0) { | |
|---|---|
| unsigned int(16) | horizontal_offset; |
| unsigned int(16) | vertical_offset; |
| unsigned int(16) | region_width; |
| unsigned int(16) | region_height; |
| } | |
| } | |

### Symantics

view_id is the identifier of the camera view which is overlapping with the camera view identified in the local position view identifier box 50.

dynamic_overlap equals to 1 indicates that the region represented by the current tier is a dynamically changing rectangular part of the base region. Otherwise, i.e. equals to 0, the region represented by the current tier is a fixed rectangular part of the base region.

object_distance indicates the distance between the cameras and the common object of interest. If it has a value of 0, no information is available for the overlap regions and the overlap region takes the default value assuming an object distance of, e.g., 100 units away.

horizontal_offset and vertical_offset give respectively the horizontal and vertical offsets of the top left pixel of the rectangular region represented by the camera view in relation to the top left pixel of the base region represented by the base camera view, in luma samples of the base region.

region_width and region_height give respectively the width and height of the rectangular region represented by the camera view, in luma samples of the base region.

The local supplementary view position box 40 may comprise zero, one or multiple adjacent view boxes 70 depending on the number of closest adjacent camera views and depending on whether the information is regarded by the content creator as valuable and therefore should be included in the local supplementary view position box 40. Correspondingly, zero, one or multiple overlap view boxes 60 can be used per local supplementary view position box 40 as is determined based on the number of overlapping camera views. Note also that the media container file can comprise zero, one or multiple local supplementary view position boxes.

The information included in the local supplementary view position box can be regarded as additional or supplementary information that can be of interest in addition to the global view information provided by the view arrangement representations. In an alternative approach, the local supplementary view position box is used and included in the media container file without the need of selecting and including any view arrangement representation.

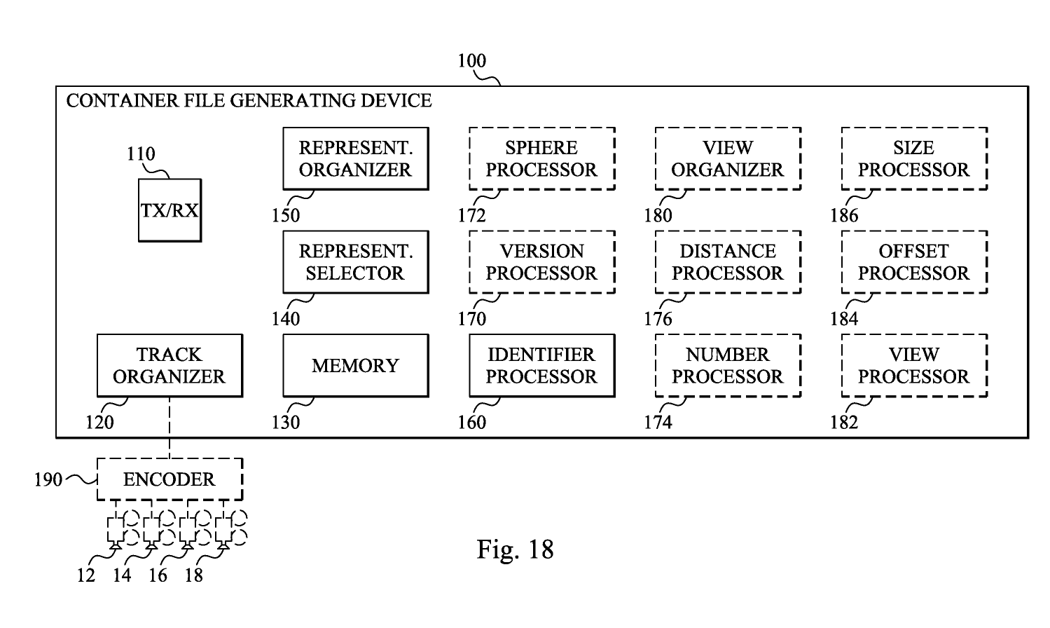

FIG. 18 is a schematic block diagram of a device for generating a media container file according to an embodiment. The device 100 comprises a track organizer 120 arranged for organizing encoded video data representative of multiple camera views of a video content in at least one media track of the media container file. The track organizer 120 can be connected to an internal or external media engine comprising equipment 12-18 for recording or generating the video data of the multiple camera views and an encoder 190 for encoding the recorded or generated video data. Alternatively, the track organizer 120 receives the video data, typically in a coded form or as uncoded video data, from a connected receiver 110 of the device 100. The receiver 110 then receives the video data through a wired or wireless communication from an external terminal in the communication system. As a further alternative, the track organizer 120 can fetch the multi-view video data from a connected media memory 130 of the device 100.

A representation selector 140 is implemented for selecting a view arrangement representation among multiple predefined view arrangement representations. The selection is further performed at least partly based on the relative positions of the multiple camera views. The selection of view arrangement representation may be performed manually by the content creator having knowledge of the camera view deployment. In such a case, the representation selector 140 comprises or is connected to a user input, which is used by the content creator for selecting the view arrangement representation. As an alternatively, coordinates of the cameras can be provided to the representation selector 140, such as through the user input or from the video data itself. The representation selector 140 then comprises processing capabilities for performing the complex calculations of defining camera view deployment and interrelationships. As the media container file is generated offline and generally in a device 100 having access to unlimited power, the tedious calculations can indeed be performed by the representation selector 140. Such calculations are generally not possible or at least disadvantageous in connection with the video decoding and rendering, in particular for thin terminals with limited computationally and processing capability, such as mobile terminals.

An identifier processor 160 is provided in the device 100 for including view identifiers of the multiple camera views in the view arrangement representation selected by the representation selector 140. In such a case, the identifier processor 160 preferably includes the view identifiers in an order describing the relative position orders of the multiple camera views in the predefined deployment and position relationship defined by the selected view arrangement representation.

The selected view arrangement representation with the view identifiers is associatively organized in the media container file relative the at least one media track by a representation organizer 150.

If the representation selector 140 selects an inline view arrangement representation, an optional version processor 170 is activated for selecting between a first inline version and a second inline version based in the relative positions of the camera views aligned in a straight line. In the former case, the identifier processor 160 includes the view identifiers of all the aligned camera views. However, if instead the second version is selected by the version identifier, the identifier processor 160 includes a start view identifier and optionally an identifier increment. This information allows a simple calculation of the camera views.

The version processor 170 selects version by investigating the respective view identifiers of the successive camera views. If the view identifiers increase or decrease with an increment or decrement when moving along the line, the version processor 170 selects the second inline version otherwise the first inline version is used.

The representation selector 140 may alternatively or in addition select a plane view arrangement representation. In such a case, the version processor 170 preferably selects between the previously described first and second plane versions. Depending on which plane version that is selected, the identifier processor 160 includes the view identifiers of all camera views present in the plane or the start_view_identifier, optionally the total number of camera views and optionally the identifier increment.

The total number of camera views may be determined by a number processor 174 based on input information included in the encoded multi-view data or from the user input.

If the representation selector 140 selects a rectangular view array arrangement representation, a number processor 174 of the device 100 includes a representation of the number of row and the number of columns of the rectangular camera view array in the rectangular view array arrangement representation. A distance processor 176 includes information of the distances between consecutive rows and columns in the rectangular view array arrangement representation.

A sphere processor 172 is activated if the representation selector 140 selects a sphere view array arrangement representation. This sphere processor 172 includes, in the arrangement representation, information of the radius and the center coordinate of the sphere, on which the multiple cameras are arranged.

If the representation selector 140 selects a stereo view arrangement representation, the identifier processor 160 includes the view identifiers of a left eye camera view and a right eye camera view in the stereo view arrangement representation.

The device 100 may optionally also comprises processors for providing supplementary information in the media container file. A view processor 182 may for instance include the view identifier of a camera view selected as a basic camera view of multiple available camera views, such as arranged on a line, on a plane, in a rectangular lattice or on a sphere. The view processor 182 may also include the view identifier of the camera view or views that is determined to be closest in terms of distance to the camera view specified as the base camera view.

A view organizer 180 can associatively organize a representation of overlapping camera views in the media container file relative the at least one media track. The view processor 182 then includes the identifiers of the basic camera view and the overlapping camera views in the representation.

The distance processor 176 or another processor of the device 100 may include information of the distance between the overlapping cameras and the overlapping object of interest. Correspondingly, an offset processor 184 includes information of an offset between the basic camera view and the overlapping camera view and a size processor includes information of the size of the overlapping region as previously described.

The media container frame generated according to an embodiment of the device 100 can be entered in the media memory 130 for a later transmission to an external unit that is to forward or process the media container file. Alternatively, the media container file can be directly transmitted to this external unit, such as a media server, transcoder or user terminal with media rendering or play-out facilities, by a transmitter 110 of the device 100.

The units 110, 120 and 140-190 of the device 100 may be provided in hardware, software or a combination of hardware and software. The device 100 may advantageously be arranged in a network node of a wired or preferably wireless, radio-based communication system. The device 100 can constitute a part of a content provider or server or can be connected thereto.

In FIG. 18 a combined unit, i.e. transceiver, comprising both reception and transmission functionality has been used. Alternatively, a dedicated receiver and a dedicated transmitter optionally connected, in wireless implementations, to separate receiving antenna and transmitting antenna or a combined receiving and transmitting antenna can be used.

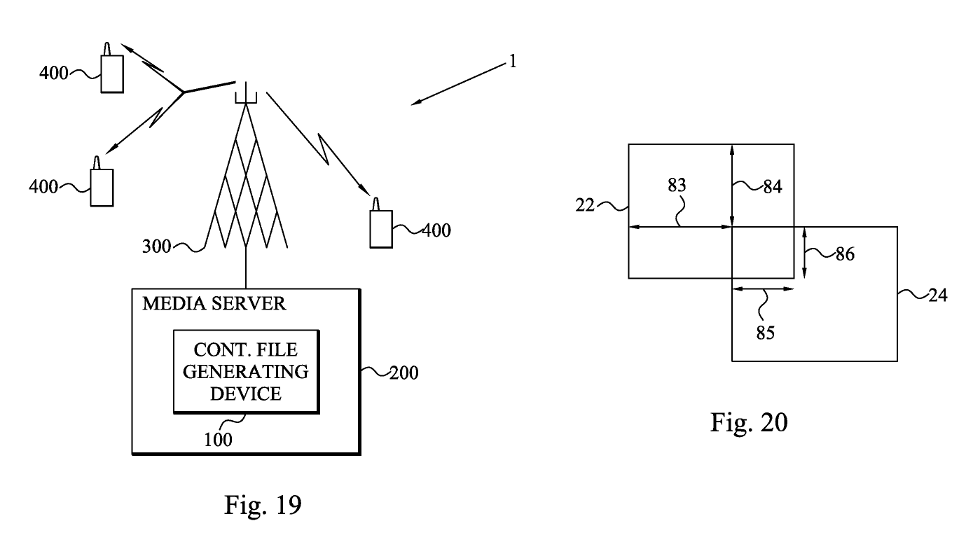

FIG. 19 is a schematic overview of a portion of a wireless communication system 1 in which embodiments may be implemented. The communication system 1 comprises one or more network nodes or base stations 300 providing communication services to connected user terminals 400. At least one of the base stations 300 comprises or is connected to a media server or provider 200 comprising the container file generating device 100 described above and disclosed in FIG. 18. The multi-view video data included in the media container file is distributed to user terminals 200 and/or other data processing devices provided in the communication system 1. In such a case, the multi-view video data can be transmitted, to user terminals 400, in a unicast transmission or in the form of a multicast or broadcast transmission as schematically illustrated in the figure.

The view arrangement representation included in the media container file provides high-level information on frequently used relationships between cameras. The view arrangement representations can be used to provide intuitive information regarding the pattern of the cameras quite easily without scanning all camera parameters and avoiding exhaustive calculations. The arrangement representations can therefore be used to easily find out which cameras and camera views that are aligned, in a plane or some other deployment pattern, which cameras are adjacent each other, which camera views are suitable for stereo rendering, etc.

The view arrangement representation and the information included therein can be used by rendering equipment, media players or other media processors, for instance, when selecting media data to further process, such as transcode or render. Thus, information of how the cameras used for recording the multi-view video data are arranged relative each other is advantageously used for processing the video data in the media container file. For instance, when rendering 3D video, the stereo view arrangement representation allows identification of the camera views and therefore the video data from these camera views to co-render in order to achieve the 3D effect.

Other examples of multi-view video data processing based on the deployment information is when one wants to switch between consecutive camera views arranged in a straight line. The inline view arrangement representation therefore allows identification of the camera views and video data from these camera views to use when switching rendering views in this way. Correspondingly, the sphere view array arrangement representation can be used if one would like to pan or move between camera views arranged on a spherical surface.

Furthermore, the information contained in the view arrangement representation can be combined with local information, e.g. whether adjacent cameras have overlapping views, to decide whether a concatenation of camera views is suitable or indeed possible. A user example of concatenation is large screens and projectors, which require the union of several camera views or a single 360° panoramic view.

The view arrangement representations can also be used in object tracking. For example, assume an object running very quickly from left to right. It would then be beneficial to know whether any horizontal inline view arrangement representations exists in the current camera array so that tracing the running object is possible.

It will be understood by a person skilled in the art that various modifications and changes may be made to the present invention without departure from the scope thereof, which is defined by the appended claims.

### REFERENCES

[1] ISO/IEC JTC1/SC29/WG11—Coding of Moving Pictures and Audio, MPEG-4 Overview, July 2000
[2] ISO/IEC 14496-15:2004—Information Technology, Coding of Audio-Visual Objects, Part 15: Advanced Video Coding (AVC) File Format
[3] ISO/IEC 14496-14:2003—Information Technology, Coding of Audio-Visual Objects, Part 14: MP4 File Format
[4] 3GPP TS 26.244 V7.3.0—3^{rd} Generation Partnership Project; Technical Specification Group Services and System Aspects; Transparent end-to-end packet switched streaming service (PSS); 3GPP file format, 2007
[5] ISO/IEC 14496-12:2005-Information Technology, Coding of Audio-Visual Objects, Part 12: ISO Base Media File Format

1-23. (canceled)

24. A method implemented by a device for generating a media container file, comprising:
organizing encoded video data representative of multiple camera views of a video content in at least one media track of said media container file;
selecting, based on relative positions of said multiple camera views, a view arrangement representation among multiple predefined view arrangement representations, wherein said multiple predefined view arrangement representations are indicative of different predefined deployment and position relationships of said multiple camera views;
including view identifiers of said multiple camera views in said selected view arrangement representation; and
associatively organizing said selected view arrangement representation in said media container file relative said at least one media track.

25. The method according to claim 24, wherein said including comprises including said view identifiers in an order describing a relative position order of said multiple camera views in a predefined deployment and position relationship defined by said selected view arrangement representation.

26. The method according to claim 24, wherein said selecting comprises selecting, based on said relative positions of said multiple camera views, a view arrangement representation among an inline view arrangement representation, a plane view arrangement representation, a rectangular view array arrangement representation, a sphere view array arrangement representation and a stereo view pair arrangement representation.

27. The method according to claim 24, wherein said selecting comprises selecting, based on said relative positions of said multiple camera views, an inline view arrangement representation, wherein said method further comprises selecting between a first inline version and a second inline version based on said relative positions of said multiple camera views, and wherein said including comprises including, if said first inline version is selected, said view identifiers, and comprises including, if said second inline version is selected, a start view identifier selected among said view identifiers and an identifier increment applicable to said start view identifier to obtain the view identifiers of at least a portion of said multiple camera views.

28. The method according to claim 24, wherein said selecting comprises selecting, based on said relative positions of said multiple camera views, a plane view arrangement representation, wherein said method further comprises selecting between a first plane version and a second plane version based on said relative positions of said multiple camera views, and wherein said including comprises including, if said first plane version is selected, said view identifiers, and comprises including, if said second plane version is selected, a start view identifier selected among said view identifiers and an identifier increment applicable to said start view identifier to obtain the view identifiers of at least a portion of said multiple camera views.

29. The method according to claim 24, wherein said selecting comprises selecting, based on said relative positions of said multiple camera views, a rectangular view array arrangement representation, said method further comprising:
including, in said rectangular view array arrangement representation, a representation of a number of rows and a representation of a number of columns of a rectangular camera view array of said multiple camera views; and
including, in said rectangular view array arrangement representation, a representation of a distance between consecutive rows and a representation of a distance between consecutive columns in said rectangular camera view array.

30. The method according to claim 24, wherein said selecting comprises selecting, based on said relative positions of said multiple camera views, a sphere view array arrangement representation, said method further comprising including, in said sphere view array arrangement representation, a representation of a radius and a representation a center coordinate of a spherical camera view array comprising said multiple camera views.

31. The method according to claim 24, wherein said selecting comprises selecting, based on said relative positions of said multiple camera views, a stereo view pair arrangement representation and said including comprises including a view identifier of a left eye camera view and a view identifier of a right eye camera view of said multiple camera views in said stereo view pair arrangement representation.

32. The method according to claim 24, further comprising associatively organizing a representation of overlapping camera views of said multiple camera views in said media container file relative said at least one media track.

33. The method according to claim 32, further comprising:
including a view identifier of a basic camera view of said multiple camera views in said representation of overlapping camera views; and
including any view identifier of any camera view of said multiple camera views overlapping said basic camera view in said representation of overlapping camera views.

34. The method according to claim 33, further comprising:
including, in said representation of overlapping camera views, information of an offset between said basic camera view and said any camera view overlapping said basic camera view; and
including, in said representation of overlapping camera views, information of a size of an overlapping region of said basic camera view and said any camera view overlapping said basic camera view.

35. A device for generating a media container file, comprising:
a track organizer configured to organize encoded video data representative of multiple camera views of a video content in at least one media track of said media container file;
a representation selector configured to select, based on relative positions of said multiple camera views, a view arrangement representation among multiple predefined view arrangement representations, wherein said multiple predefined view arrangement representations are indicative of different predefined deployment and position relationships of said multiple camera views;
an identifier processor configured to include view identifiers of said multiple camera views in said view arrangement representation selected by said representation selector; and
a representation organizer configured to associatively organize said view arrangement representation selected by said representation selector in said media container file relative said at least one media track.

36. The device according to claim 35, wherein said identifier processor is configured to include said view identifiers in an order describing a relative position order of said multiple camera views in a predefined deployment and position relationship defined by said view arrangement representation selected by said representation selector.

37. The device according to claim 35, wherein said representation selector is configured to select, based on said relative positions of said multiple camera views, a view arrangement representation among an inline view arrangement representation, a plane view arrangement representation, a rectangular view array arrangement representation, a sphere view array arrangement representation and a stereo view pair arrangement representation.

38. The device according to claim 35, wherein said representation selector is configured to select, based on said relative positions of said multiple camera views, an inline view arrangement representation, wherein said device further comprises a version processor configured to include, in said inline view arrangement representation and based on said relative positions of said multiple camera views, a version identifier of a first inline version or a second inline version, wherein said identifier processor is configured to include, if said version processor includes the version identifier of said first inline version, said view identifiers, and to include, if said version processor includes the version identifier of said second inline version, a start view identifier selected among said view identifiers and an identifier increment applicable to said start view identifier to obtain view identifiers of at least a portion of said multiple camera views.

39. The device according to claim 35, wherein said representation selector is configured to select, based on said relative positions of said multiple camera views, a plane view arrangement representation, wherein said device further comprises a version processor configured to include, in said plane view arrangement representation and based on said relative positions of said multiple camera views, a version identifier of a first plane version or a second plane version, and wherein said identifier processor is configured to include, if said version processor includes the version identifier of said first plane version, said view identifiers, and to include, if said version processor includes the version identifier of said second plane version, a start view identifier selected among said view identifiers and an identifier increment applicable to said start view identifier to obtain view identifiers of a at least a portion of said multiple camera views.

40. The device according to claim 35, wherein said representation selector is configured to select, based on said relative positions of said multiple camera views, a rectangular view array arrangement representation, said device further comprising:
a number processor configured to include, in said rectangular view array arrangement representation, a representation of a number of rows and a representation of a number of columns of a rectangular camera view array of said multiple camera views; and
a distance processor configured to include, in said rectangular view array arrangement representation, a representation of a distance between consecutive rows and a representation of a distance between consecutive columns in said rectangular camera view array.

41. The device according to claim 35, wherein said representation selector is configured to select, based on said relative positions of said multiple camera views, a sphere view array arrangement representation, said device further comprising a sphere processor configured to include, in said sphere view array arrangement representation, a representation of a radius and a representation a center coordinate of a spherical camera view array comprising said multiple camera views.

42. The device according to claim 35, wherein said representation selector is configured to select, based on said relative positions of said multiple camera views, a stereo view pair arrangement representation and said identifier processor is configured to include a view identifier of a left eye camera view and a view identifier of a right eye camera view of said multiple camera views in said stereo view pair arrangement representation.

43. The device according to claim 35, further comprising a view organizer configured to associatively organize a representation of overlapping camera views of said multiple camera views in said media container file relative said at least one media track.

44. The device according to claim 43, further comprising a view processor configured to include a view identifier of a basic camera view of said multiple camera views in said representation of overlapping camera views, and to include any view identifier of any camera view of said multiple camera views overlapping said basic camera view in said representation of overlapping camera views.

45. The device according to claim 44, further comprising:
an offset processor configured to include, in said representation of overlapping camera views, information of an offset between said basic camera view and said any camera view overlapping said basic camera view; and
a size processor configured to include, in said representation of overlapping camera views, information of a size of an overlapping region of said basic camera view and said any camera view overlapping said basic camera view.
